(19) United States
(12) Patent Application Publication
(10) Pub. No.: US 2018/0346000 A1
(43) Pub. Date: Dec. 6, 2018

(54) RAILWAY VEHICLE HAVING AN OPTIMIZED ELECTRICITY DISTRIBUTION NETWORK

(71) Applicant: ALSTOM Transport Technologies, Saint Ouen (FR)

(72) Inventor: Jean-Michel DELEMOTTE, LA TREMBLADE (FR)

(21) Appl. No.: 15/993,057

(22) Filed: May 30, 2018

(30) Foreign Application Priority Data
May 31, 2017 (FR) 17 54815

(51) Int. Cl. B61G 5/10; H02G 3/30

(52) U.S. Cl. CPC B61G 5/10; B60L 2230/12; B60L 2200/26; H02G 3/30

(57) ABSTRACT

Disclosed is a railway vehicle including a first car having a first end, and a second car having a second end, the first and second ends being arranged across from one another and separated by an inter-circulation space including an inter-circulation device. The first and second cars are equipped with first and second high-voltage cables and first and second low-voltage power cables. Each car has a casing supported at its end, the power cables all passing through this casing. This casing includes a support member for the power cables. The support members are arranged across from one another, the power cables extending freely in the inter-circulation space between the support members, the inter-circulation space and in particular the inter-circulation device being free of any support element for the power cables.

The present invention relates to a railway vehicle, having at least two successive cars, with an electricity distribution network extending over these cars. These two cars are typically separated by an inter-circulation area comprising an inter-circulation device.

The electricity distribution network is intended to supply electricity to electrical equipment of the railway vehicle, in particular electric motors and auxiliary equipment such as lighting, heating, ventilation, air-conditioning, etc. systems.

The distribution network includes high-voltage HV power cables, in particular for powering electric motors, and low-voltage LV power cables, in particular for powering auxiliary equipment.

Typically, the cables go from one car to another through the inter-circulation space, and in particular the inter-circulation device, at the roof. There are many of these cables, which involves complex cabling.

The invention in particular aims to improve this situation by proposing a railway vehicle in which the cabling between two successive cars is simplified and in which the bulk is reduced.

To that end, the invention in particular relates to a railway vehicle, comprising at least first and second successive cars, such that:
the first car has a first end, and the second car has a second end, the first and second ends being arranged across from one another and separated by an inter-circulation space comprising an inter-circulation device,
the first car is equipped with first high-voltage power cables and first low-voltage power cables, and the second car is equipped with second high-voltage power cables and second low-voltage power cables,
   characterized in that:
the first car includes a first casing supported at its first end, the first high-voltage and low-voltage power cables all passing through this first casing, the first casing comprising a first support and guide member for the high-voltage and low-voltage power cables,
the second car includes a second casing supported at its second end, the second high-voltage and low-voltage power cables all passing through this second casing, the second casing comprising a second support and guide member for the high-voltage and low-voltage power cables,
the first and second support members are arranged across from one another, the power cables extending freely in the inter-circulation space between the first and second support members, the inter-circulation space and in particular the inter-circulation device being free of any support element for the power cables.

The invention makes it possible to arrange many cables simply and in an orderly manner, without generating constraints on the cables during movements between the cars, the cables extending freely in the inter-circulation space.

A railway vehicle according to the invention may further include one or more of the following features, considered alone or according to all technically possible combinations.
The first support member includes a plurality of first guide orifices, each for guiding a first respective cable, each first guide orifice being oriented downward in a longitudinal direction, in a first sense going from the first support member toward the second support member.
The second support member includes a plurality of second guide orifices, each for guiding a second respective cable, each second guide orifice being oriented downward in a longitudinal direction, in a second sense going from the second support member toward the first support member.
The first support member is formed by a wall of the first casing, and/or the second support and guide member is formed by a wall of the second casing.
The first support member includes first connectors for the first high-voltage and/or low-voltage cables, the second support member includes second connectors for the second high-voltage and/or low-voltage cables, and intermediate cables extend between the first and second support members, each intermediate cable being connected to the respective one of the first cables and to the respective one of the second cables.
At least some cables, in particular the low-voltage power cables, extend over the two cars, and in other words are shared by the two cars.
Each casing extends transversely to the corresponding car, substantially over the entire width of this car, this casing having two transverse walls, separated in a longitudinal direction, and a cover closing the casing (28, 30) upwardly and preferably also on the sides.
Each car has a respective body comprising a respective roof, each casing being supported completely by the roof of the corresponding body.
Each support member has a support part for the corresponding high-voltage cables, and a support part for the corresponding low-voltage cables, these parts being separate.

The invention will be better understood upon reading the following description, provided solely as an example and done in reference to the appended figures, in which:

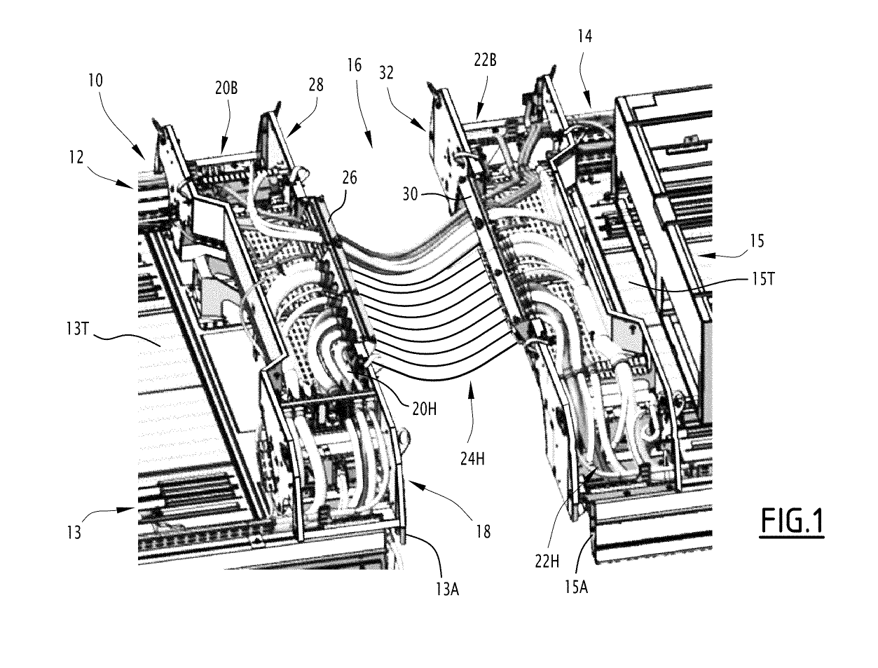

FIG. 1 is a partial perspective view of a railway vehicle according to one example embodiment of the invention, at an inter-circulation between two successive cars of the railway vehicle;

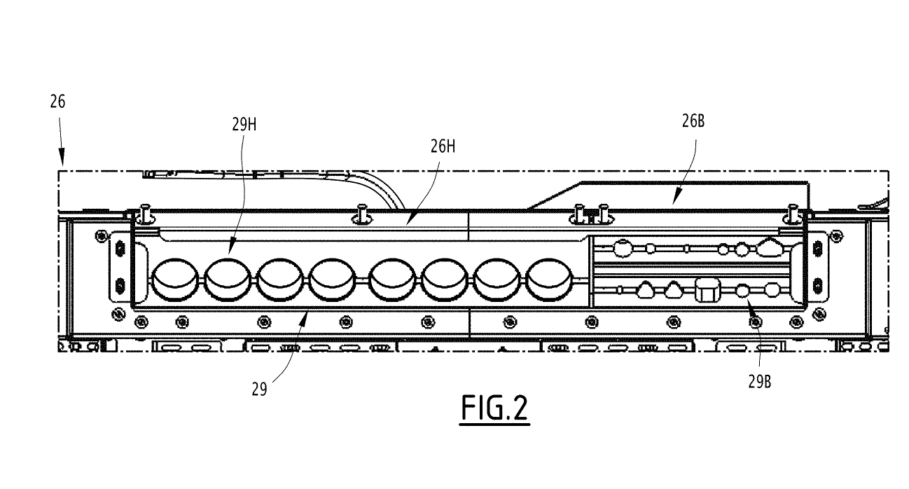

FIG. 2 is a front view of a support member for cables equipping the railway vehicle of FIG. 1.

FIG. 1 shows a railway vehicle designated by general reference 10.

The railway vehicle 10 comprises at least two cars, in particular a first car 12 and a second car 14 that are adjacent, separated traditionally by an inter-circulation space 16 comprising an inter-circulation device.

The railway vehicle 10 for example includes other cars, not shown, all of the adjacent cars advantageously being connected to one another in the same way as the first 12 and second 14 cars.

The first car 12 includes a first body 13 comprising a first roof 13T and extending in a longitudinal direction up to a first end 13A.

Likewise, the second car 14 includes a second body 15 comprising a second roof 15T and extending in a longitudinal direction up to a second end 15A.

The first 13A and second 15A ends are arranged across from one another.

The inter-circulation device traditionally has mechanical connecting means for connecting the first 12 and second 14 cars together, to provide the cohesion of the railway vehicle 10, while allowing relative rotations of the first 12 and second 14 cars, for passing curves, dents and humps of the railroad track.

The railway vehicle 10 includes an electricity distribution network 18 extending along this railway vehicle, in particular over the first car 12 and the second car 14. The distribution network 18 is intended to distribute electricity along the railway vehicle 10 to supply power to electrical equipment of the railway vehicle 10, in particular electric motors traditionally pulling the vehicle 10, and auxiliary equipment such as lighting systems, display systems, air-conditioning systems, etc.

More particularly, the first car 12 has first electrical distribution power cables, comprising first high-voltage power cables 20H and first low-voltage power cables 20B, and the second car 14 has second power cables, comprising second high-voltage power cables 22H and second low-voltage power cables 22B.

For example, at least some cables, in particular the low-voltage power cables 20B, 22B, extend over the two cars 12, 14, and in other words are shared by the two cars 12, 14.

Conversely, at least some cables, in particular the high-voltage power cables 20H, 22H, are connected to one another by intermediate high-voltage cables 24H that extend in the inter-circulation space 16, and that will be described later in more detail. More particularly, each high-voltage cable 20H is connected to a respective one of the second high-voltage cables 22H, via a respective intermediate cable 24H.

The first 20H, 20B and second 22H, 22B cables connected to one another together form the distribution network 18.

According to one alternative, the high-voltage power cables 20H, 22H are directly connected to one another with no intermediary. According to another alternative, the high-voltage power cables extend over both cars 12, 14, and in other words are shared by the two cars 12, 14.

According to the invention, the first car 12 has, near its first end 13A, a first support and guide member 26 for the first high-voltage 20H and low-voltage 20B power cables.

Advantageously, the first car 12 has a first casing 28 supported at its first end 13A, the first high-voltage 20H and low-voltage 20B power cables all passing through this first casing 28. By grouping the high voltage and low voltage together in a same casing, the implementation of the distribution network 18 is made easier, in particular regarding the assembly, disassembly, maintenance, etc.

The first casing 28 extends transversely to the first car 12, substantially over the entire width of this first car 12. The first casing 28 in particular includes two transverse walls, separated in the longitudinal direction, and a cover (not shown in the figure) closing the first casing 28 upwardly and preferably also on the sides. One of the transverse walls is formed by the first support member 26, which is shown in more detail in FIG. 2.

The first casing 28, in particular the first support member 26, is completely supported by the roof 13T of the first body 13.

The first support member 26 includes a plurality of first guide orifices 29, each for guiding a first respective cable 20H, 20B. Each first guide orifice 29 is oriented downward in the longitudinal direction, in a first direction going from the first car 12 toward the second car 14. Thus, the cables are guided downward upon leaving the first support member 26, in the inter-circulation space 16, as shown in FIG. 1.

The first support member 26 has a support part 26H for the first high-voltage cables 20H, and a support part 26B for the first low-voltage cables 20B, the parts 26H and 26B being separate.

The first guide orifices 29 include high-voltage guide orifices 29H, arranged in the support part 26H of the first high-voltage cables 20H, and low-voltage guide orifices 29B, arranged in the support part 26B of the first low-voltage cables 20B.

Each high-voltage guide orifice 29H is for example intended to receive a high-voltage connector, able to be connected on the one hand to one of the first high-voltage cables 20H, on the side of the first casing 28, and on the other hand to one of the intermediate cables 24H on the side of the inter-circulation space 16.

Furthermore, each low-voltage guide orifice 29B is for example intended for the passage of the low-voltage cables 20B, 22B.

Alternatively, at least some cables, in particular the low-voltage power cables 20B, 22B, are connected to one another by intermediate low-voltage cables that extend in the inter-circulation space 16. In this alternative, each low-voltage guide orifice 29B is for example intended to receive a high-voltage connector, able to be connected on the one hand to one of the first low-voltage cables 20B, on the side of the first casing 28, and on the other hand to one of the low-voltage intermediate cables on the side of the inter-circulation space 16.

The second car 14 bears, near its second end 15A, a second support and guide member 30 for second high-voltage 22H and low-voltage 22B power cables.

Advantageously, the second car 14 has a second casing 32 supported at its second end 15A, the second high-voltage 22H and low-voltage 22B power cables all passing through this second casing 32. By grouping the high voltage and low voltage together in a same casing, the implementation of the distribution network 18 is made easier, in particular regarding the assembly, disassembly, maintenance, etc.

The second casing 32 extends transversely to the second car 14, substantially over the entire width of this second car 14. The second casing 32 in particular includes two transverse walls, separated in the longitudinal direction, and a cover (not shown in the figure) closing the second casing 32 upwardly and preferably also on the sides. One of the transverse walls is formed by the second support member 30.

The second casing 32, in particular the second support member 30, is completely supported by the roof 15T of the second body 15.

The second support member 30 is similar to the first support member 26 in all points.

In particular, the first support member 30 has a plurality of second guide orifices 29, each for guiding a second respective cable 22H, 22B. Each second guide orifice is oriented downward in the longitudinal direction, in a second direction going from the second car 14 toward the first car 12. Thus, the cables are guided downward upon leaving the second support member 30, in the inter-circulation space 16, as shown in FIG. 1.

Similarly to the first support member 26, the second support member 30 has a support part for the second high-voltage cables 22H, and a support part for the second low-voltage cables 22B.

The second guide orifices include high-voltage guide orifices, arranged in the support part of the second high-voltage cables 22H, and low-voltage guide orifices, arranged in the support part of the second low-voltage cables 22B.

Each high-voltage guide orifice is for example intended to receive a high-voltage connector, able to be connected on the one hand to one of the second high-voltage cables 22H, on the side of the second casing 32, and on the other hand to one of the intermediate cables 24H on the side of the inter-circulation space 16.

Furthermore, each low-voltage guide orifice is for example intended for the passage of the low-voltage cables 20B, 22B.

The second support member 30 is arranged across from the first support member 26, symmetrically, such that the high-voltage part 26H of the first support member 26 is arranged across from the high-voltage part of the second support member 30, and the low-voltage part 26B of the first support member 26 is arranged across from the low-voltage part of the second support member 30.

In the example shown in FIG. 1, each first high-voltage cable 20H is connected to a second high-voltage cable 22H located across from it. Alternatively, the cables are crossed and are therefore connected to cables that are not across from them.

According to the invention, the power cables, in particular the low-voltage cables 20B, 22B and the intermediate cables 24H, extend freely in the inter-circulation space 16 between the first 26 and second 30 support members, the inter-circulation space 16 and in particular the inter-circulation device being free of any support element for the power cables. In other words, only the support elements are formed by the support members 26, 30, which are not supported by elements of the inter-circulation space 16, and in particular the inter-circulation device, but by the respective body 13, 15.

Thus, the cables are not subject to any constraint during the movements between the first and second cars.

Furthermore, since the inter-circulation device does not bear any support element, the invention can be used in a standardized manner irrespective of the type of inter-circulation device.

It will be noted that the invention is not limited to the embodiment previously described, and could assume the form of various additional alternatives.

1. A railway vehicle, comprising at least first and second successive cars, such that:
the first car has a first end, and the second car has a second end, the first and second ends being arranged across from one another and separated by an inter-circulation space comprising an inter-circulation device,
the railway vehicle comprises power cables, including first high-voltage power cables and first low-voltage power cables equipping the first car, and second high-voltage power cables and second low-voltage power cables equipping the second car,
wherein:
the first car includes a first casing supported at its first end, the first high-voltage and first low-voltage power cables all passing through this first casing, the first casing comprising a first support and guide member for the first high-voltage and first low-voltage power cables,
the second car includes a second casing supported at its second end, the second high-voltage and second low-voltage power cables all passing through this second casing, the second casing comprising a second support and guide member for the second high-voltage and second low-voltage power cables,
the first and second support members are arranged across from one another, at least some power cables extending freely in the inter-circulation space between the first and second support members, the inter-circulation space and in particular the inter-circulation device being free of any support element for the power cables.

2. The railway vehicle according to claim 1, wherein the first support member includes a plurality of first guide orifices, each for guiding a first respective first high-voltage or first low-voltage power cable, each first guide orifice being oriented downward in a longitudinal direction, in a first way going from the first support member toward the second support member.

3. The railway vehicle according to claim 1, wherein the second support member includes a plurality of second guide orifices, each for guiding a second respective second high-voltage or second low-voltage power cable, each second guide orifice being oriented downward in a longitudinal direction, in a second way going from the second support member toward the first support member.

4. The railway vehicle according to claim 1, wherein the first support member is formed by a wall of the first casing.

5. The railway vehicle according to claim 1, wherein the second support member is formed by a wall of the second casing.

6. The railway vehicle according to claim 1, wherein:
the first support member has first connectors for the first high-voltage and/or first low-voltage cables,
the second support member has second connectors for the second high-voltage and/or second low-voltage cables,
the power cables include intermediate cables extending between the first and second support members, each intermediate cable being connected to a respective one of the first high-voltage or first low-voltage cables and to a respective one of the second high-voltage or second low-voltage cables.

7. The railway vehicle according to claim 1, wherein at least some power cables, in particular the first and second low-voltage power cables, extend over the first and second cars, and in other words are shared by the first and second cars.

8. The railway vehicle according to claim 1, wherein each first and second casing extends transversely to the corresponding first or second car, over the entire width of this first or second car, this first or second casing having two transverse walls, separated in a longitudinal direction, and a cover closing the first or second casing upwardly.

9. The railway vehicle according to claim 1, wherein each first and second car has a respective body comprising a respective roof, each first and second casing being supported completely by the roof of the corresponding body.

10. The railway vehicle according to claim 1, wherein each first and second support member has a support part for the corresponding first or second high-voltage cables, and a support part for the corresponding first or second low-voltage cables, these support parts being separate.
